(19) United States
(12) Patent Application Publication
(10) Pub. No.: US 2017/0094620 A1
(43) Pub. Date: Mar. 30, 2017

(54) TIME SYNCRONIZATION DEVICE, BASE STATION, AND METHOD FOR SYNCRONIZING TIME

(71) Applicant: FUJITSU LIMITED, Kawasaki-shi (JP)

(72) Inventor: Kiyotaka YAGO, Sendai (JP)

(73) Assignee: FUJITSU LIMITED, Kawasaki-shi (JP)

(21) Appl. No.: 15/248,594

(22) Filed: Aug. 26, 2016

(30) Foreign Application Priority Data
Sep. 29, 2015 (JP) 2015-191087

(51) Int. Cl. H04W 56/00

(52) U.S. Cl. CPC H04W 56/001; H04W 84/20

(57) ABSTRACT

A time synchronization device obtains, at each of time points, a time difference between a time indicated by one communication device when transmitting a packet and a time indicated by the remaining communication device when receiving the packet. The time synchronization device corrects, for each of multiple coefficients, the obtained time difference by adding a product of a time period from a reference time point to a time point when the time difference is obtained and the coefficient to the time difference; calculates a fluctuation parameter for each coefficients, the fluctuation parameter increasing as an absolute value of a fluctuation rate of the corrected time difference with respect to time increases; selects a coefficient related to the calculated fluctuation parameter representing a smallest fluctuation rate among the coefficients; and synchronizes times indicated by the two communication device with each other using the time difference corrected with the selected coefficient.

### CROSS-REFERENCE TO RELATED APPLICATION

This application is based upon and claims the benefit of priority of the prior Japanese Patent application No. 2015-191087, filed on Sep. 29, 2015, the entire contents of which are incorporated herein by reference.

### FIELD

The embodiment discussed herein relates to a time synchronization device, a base station, and a method for synchronizing a time.

### BACKGROUND

A time synchronization device that synchronizes the times of respective communication devices with each other has been known to the public (see, for example, Patent Literature 1). A time synchronization device estimates round-trip delay times of a packet between communication devices at respective different multiple time points and further estimates a frequency deviation based on the estimated round-trip delay times using a scheme of linear regression. A frequency deviation is a difference in frequency of a clock signal between communication devices. A clock signal is regarded as a reference of a time. The time synchronization device synchronizes the times indicated by the communication devices with each other on the basis of the estimated frequency deviation.

### RELATED ART REFERENCE

### Patent Literature

[Patent Literature 1] Japanese Laid-open Patent Publication No. 2013-121014

### SUMMARY

The number of packets transmitted in a communication network tends to easily fluctuate. Accordingly, a time (e.g., a packet transmission time) taken to receive a packet in a communication device since a sender communication device has sent the same packet tends to easily fluctuate. For the above, the precision of estimating the frequency deviation using a scheme of linear regression also tends to degrade. This sometimes hinders the above time synchronization device from synchronizing the respective times of communication devices with each other with high accuracy.

According to an aspect of an embodiment, a time synchronization device includes a time difference obtainer, a time difference corrector, a fluctuation parameter calculator, a coefficient selector, and a time synchronizer.

The time difference obtainer that obtains, at each of a plurality of time points, a time difference between a time indicated by one of a first communication device and a second communication device at a time point when the one communication device transmits a packet and a time indicated by a remaining one of the first communication device and the second communication device at a time point when the remaining communication device receives the packet.

The time difference corrector that corrects, for each of a plurality of coefficients being different from one another, the obtained time difference by adding a product of a time period from a reference time point to a time point when the time difference is obtained and the coefficient to the time difference.

The fluctuation parameter calculator that calculates a fluctuation parameter for each of the plurality of coefficients, the fluctuation parameter increasing as an absolute value of a fluctuation rate of the corrected time difference with respect to time increases.

The coefficient selector that selects a coefficient related to the calculated fluctuation parameter representing a smallest fluctuation rate among the plurality of coefficients.

The time synchronizer that synchronizes a time indicated by the first communication device with a time indicated by the second communication device using the time difference corrected with the selected coefficient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a sequence diagram illustrating an example of a process of transmitting and receiving messages to synchronize a time;

FIG. 2 is a time chart illustrating an example of relationship between a 1 PPS signal that each device generates and a point of time when messages are transmitted and received;

FIG. 3 is a sequence diagram illustrating an example of a fluctuation in time difference with time;

FIG. 4 is a sequence diagram illustrating an example of a fluctuation in time difference with time;

FIG. 5 is a block diagram schematically illustrating an example of the configuration of a wireless communication system according to a first embodiment;

FIG. 6 is a block diagram schematically illustrating an example of the configuration of a base station in FIG. 5;

FIG. 7 is a block diagram schematically illustrating an example of the configuration of a synchronization processor in FIG. 6;

FIG. 8 is a table illustrating an example of correcting coefficients that a synchronization processor in FIG. 6 generates;

FIG. 9 is a graph illustrating an example of a time difference that a synchronization processor in FIG. 6 uses to calculate a fluctuation parameter;

FIG. 10 is a graph illustrating an example of a fluctuation in a fluctuation parameter that a synchronization processor in FIG. 6 calculates with correcting coefficients; and

FIG. 11 is a flow diagram illustrating an example of a procedural steps that a base station in FIG. 5 carries out to synchronize a time with the reference time.

### DESCRIPTION OF EMBODIMENTS

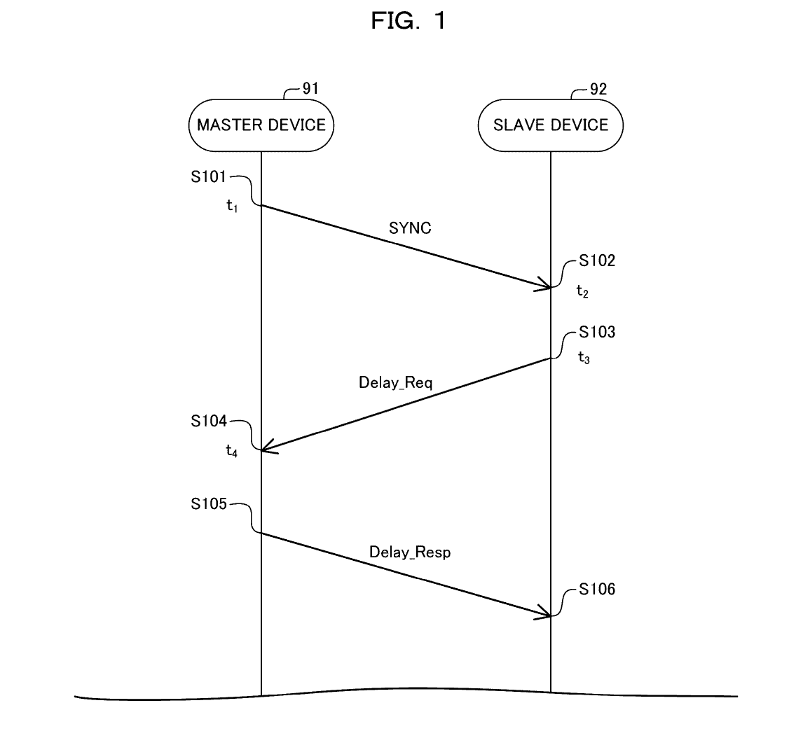

As illustrated in FIG. 1, a technique called Precision Time Protocol (PTP) transmits three types of message in the form of packets to synchronize the times between a master device 91 and a slave device 92, for example. The PTP is defined in terms of The Institute of Electrical and Electronics Engineers, Inc. (abbreviated IEEE) 1588.

First, at a time point representing a time t₁ indicated by a clock provided in the master device 91, the master device 91 transmits a synchronization message (SYNC message) containing the time t₁ to the slave device 92 (step S101 in FIG. 1).

At a time point representing a time t₂ indicated by a clock provided in the slave device 92, the slave device 92 receives the synchronization message (step S102 in FIG. 1).

Then, at a time point representing a time t₃ indicated by the clock provided in the slave device 92, the slave device 92 transmits a delay request message (Delay Req message) to the master device 91 (step S103 in FIG. 1).

At a time point representing a time t₄ indicated by the clock provided in the master device 91, the master device 91 receives the delay request message (step S104 in FIG. 1).

After that, the master device 91 transmits a delay response message (Delay Resp message) containing the time t₄ to the slave device 92 (step S105 in FIG. 1).

Then the slave device 92 receives the delay response message (step S106 in FIG. 1).

The slave device 92 obtains the times t₁-t₄ in the above process. Then the slave device 92 obtains a first time difference tₘₛ and a second time difference tₛₘ based on the obtained times t₁-t₄, using the following Expressions 1 and 2.

tₘₛ=t₂−t₁ [Expression 1]

tₛₘ=t₄−t₃ [Expression 2]

The first time difference tₘₛ is a difference between the time t₁ indicated by the master device 91 at a time point when the master device 91 transmits a synchronization message and the time t₂ indicated by the slave device 92 at a time point when the slave device 92 receives the synchronization message. The second time difference tₛₘ is a difference between the time t₃ indicated by the slave device 92 at a time point when the slave device 92 transmits a delay request message and the time t₄ indicated by the master device 91 at a time point when the master device 91 receives the delay request message.

Next, the slave device 92 determines a time correcting amount At on a time indicated by the clock provided in the slave device 92, using Expression 3.

$$Δ t = \frac{{t}_{sm} - {t}_{ms}}{2} \qquad [ Expression 3 ]$$

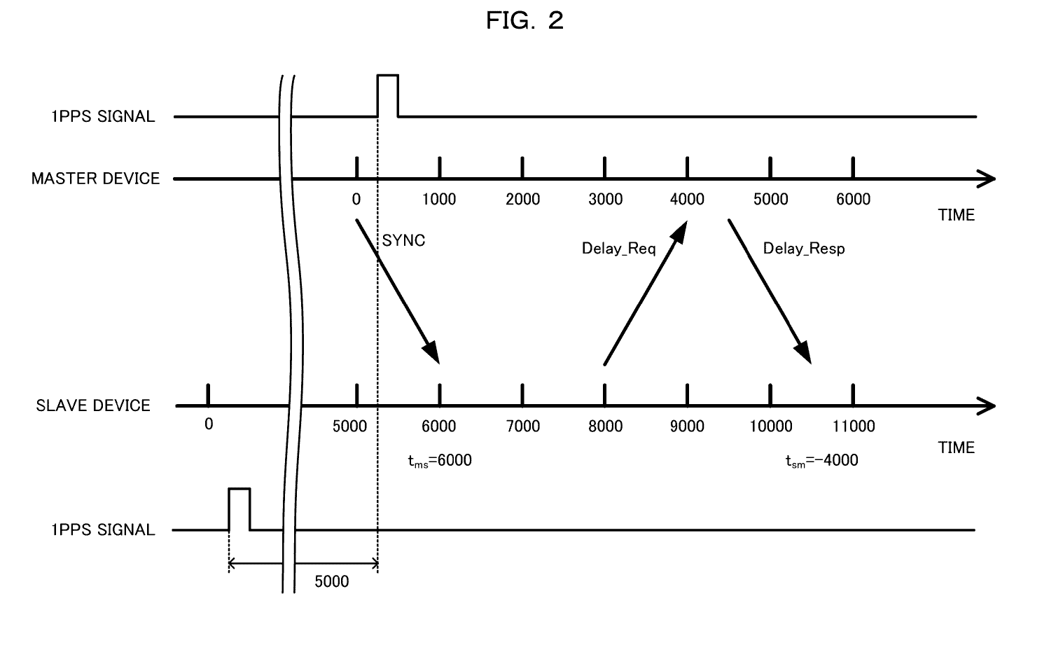

For example, as illustrated in FIG. 2, the description here assumes that the time indicted by the clock provided in the slave device 92 is earlier by 5000 ns than the time indicated by the clock provided in the master device 91 and also assumes that a message takes 1000 ns to reach one of the master device 91 and the slave device 92 since the other one of the devices 91 and 92 has transmitted the message.

Accordingly, in this case, the slave device 92 generates a pulse of a 1 PPS signal at a time point earlier by 5000 ns than a time point when the master device 91 generates a pulse of a 1 PPS signal. Here, the term “PPS” is an abbreviation for Pulse Per Second, and a 1 PPS signal has a single pulse for each second.

In this case, through communicating with the master device 91 by the three messages, the slave device 92 obtains 0 ns, 6000 ns, 8000 ns, and 4000 ns for the times t₁ through t₄, respectively. Accordingly, the slave device 92 obtains 6000 ns and −4000 ns for the first time difference tₘₛ and the second time difference tₛₘ, respectively.

Consequently, the slave device 92 obtains the time correcting amount Δt of −5000 ns. Then the slave device 92 corrects the clock provided in the slave device 92 to indicate a time earlier by 5000 ns than the time that the same clock currently indicates. This means that the clock provided in the slave device 92 is corrected such that the slave device 92 generates a pulse of a 1 PPS signal at a time point later by 5000 ns than a time currently set.

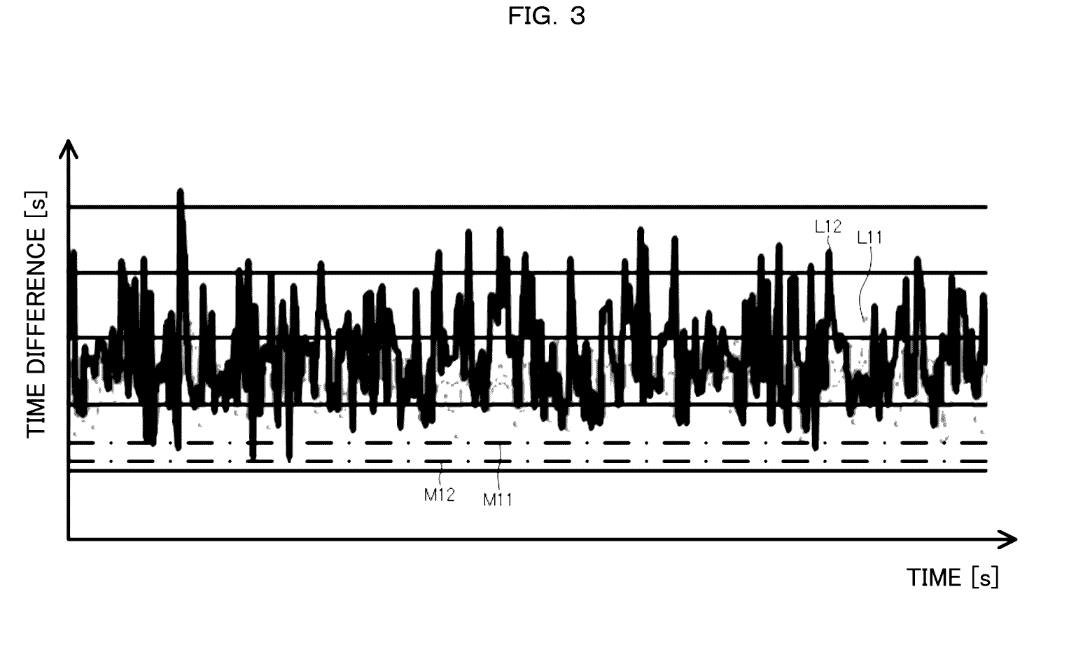

The number of packets transmitted in a communication network tends to easily fluctuate. Accordingly, a time (e.g., a packet transmission time) taken to receive a packet in a communication device since a sender communication device has sent the same packet tends to easily fluctuate. Accordingly, as illustrated in FIG. 3, the time differences tₘₛ and tₛₘ tend to largely fluctuate as the time passes. The curves L11 and L12 represent the first time difference tₘₛ and the second time difference tₛₘ, respectively.

A shorter packet transmission time brings the time differences tₘₛ and tₛₘ closer to a time difference between the time indicated by the clock provided in the master device 91 and the time indicated by the clock provided in the slave device 92 at a certain time point. Accordingly, a time correcting amount At is preferably determined on the basis of the minimum value M11 of the first time difference tₘₛ of a predetermined time period and the minimum value M12 of the second time difference tₛₘ of the predetermined time period.

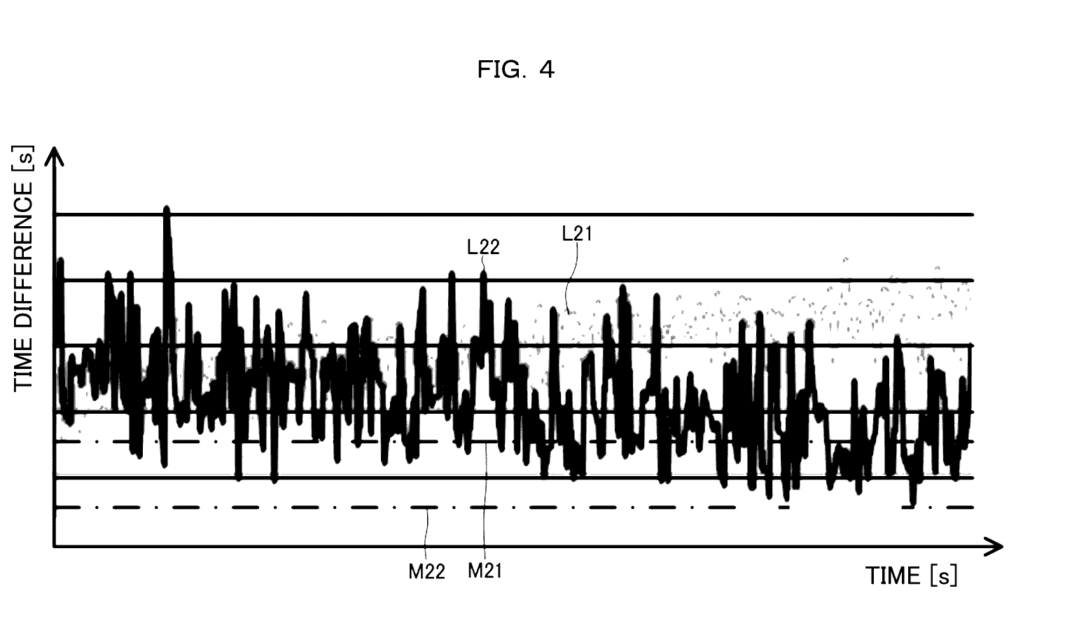

In some cases, a frequency deviation nonetheless occurs. A frequency deviation is a difference in frequency of an oscillation signal, on which the time indicated by a clock is based, between the master device 91 and the slave device 92. As illustrated in FIG. 4, the time differences tₘₛ and tₛₘ in this case increase or decrease as the time passes. The curves L21 and L22 represent the first time difference tₘₛ and the second time difference tₛₘ, respectively.

In this case, the minimum value M21 of the first time difference tₘₛ of a predetermined time period and the minimum value M22 of the second time difference tₛₘ of the predetermined time period have difficulty in reflecting the difference between a time indicated by the clock provided in the master device 91 and a time indicated by the clock provided in the slave device 92 at a certain time point. Accordingly, even using the minimum values M21 and M22 of the time difference tₘₛ and tₛₘ of the predetermined time period, the slave device 92 may sometimes fail to determine an appropriate time correcting amount Δt, which may result in failure of precisely synchronization of the times of the devices with each other. For example, in wireless communication in conformity with Time Division Duplex (TDD) scheme, the above problem may degrade the communication quality.

Hereinafter, description will now be made in relation to a first embodiment with reference to the drawings. The following embodiment is exemplary, so there is no intention to exclude application of various modifications and techniques not suggested in the following description to the embodiment. Throughout accompanying drawings of the embodiments, like reference numbers designate the same or substantially identical parts and elements unless changes and modification are specified.

### First Embodiment

(Configuration)

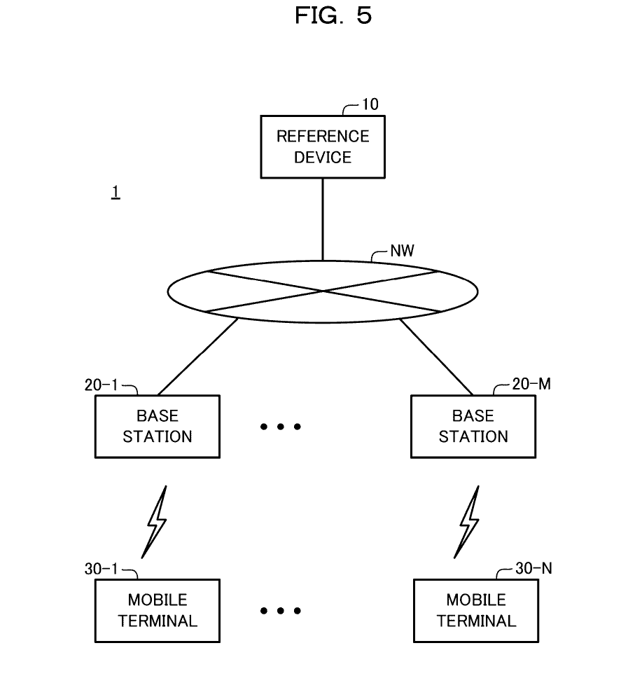

For example, as illustrated in FIG. 5, a wireless communication system 1 of the first embodiment includes a reference device 10, M base stations 20-1, . . . , 20-M, and N mobile terminals 30-1, . . . , 30-N. In this example, the symbol M represents an integer of one or more. Hereinafter, the base stations 20-m, when not needing to be discriminated from each other, is represented to be the base station 20. Here, the symbol m represents each integer of one to M. In this example, the symbol N represents an integer of one or more. Hereinafter, the mobile terminals 30-n, when not needing to be discriminated from each other, is represented to be the mobile terminal 30. Here, the symbol n represents each integer of one to N. The reference device 10 and the base station 20 are each an example of a communication device.

The wireless communication system 1 executes wireless communication between the base station 20-m and the mobile terminal 30-n in conformity with a predetermined communication scheme, which is exemplified by Long Term Evolution (LTE), LTE-Advanced, or Worldwide Interoperability for Microwave Access (WiMAX).

The base station 20-m forms a wireless area. Alternatively, the base station 20-m may form multiple wireless areas. A wireless area may also be referred to as a cell, a coverage area, and a communication area.

The base station 20-m wirelessly communicates with a mobile terminal 30-n positioned within the local wireless area, which the same base station 20-m forms. In this example, the base station 20-m provides a wireless resource in the local wireless area. A wireless resource of the first embodiment is specified with time and frequency. The base station 20-m communicates with a mobile terminal 30-n positioned in the local wireless area provided by the same base station 20-m, using the wireless resource provided in the local wireless area.

The reference device 10 includes a clock indicating a time (e.g., the reference time) that is regarded as the reference in the wireless communication system 1. The reference device 10 is communicably connected to the base station 20-m via a communication network NW. The reference device 10 may have the function the same as that of the base station 20-m in addition to the function as the reference device 10.

The base station 20-m is provided with a clock indicating a time in the same base station 20-m. The base station 20-m synchronizes a time indicated by the clock provided in the base station 20-m with the reference time by communicating a synchronization message, a delay request message, and a delay response message of PTP with the reference device 10.

Accordingly, the reference device 10 is an example of a master device of PTP and the base station 20-m is an example of a salve device of PTP.

Here, the synchronization message, the delay request message, and the delay response message of PTP are transmitted in the form of packets of the first embodiment. The synchronization message, the delay request message, and the delay response message are also referred to as PTP messages.

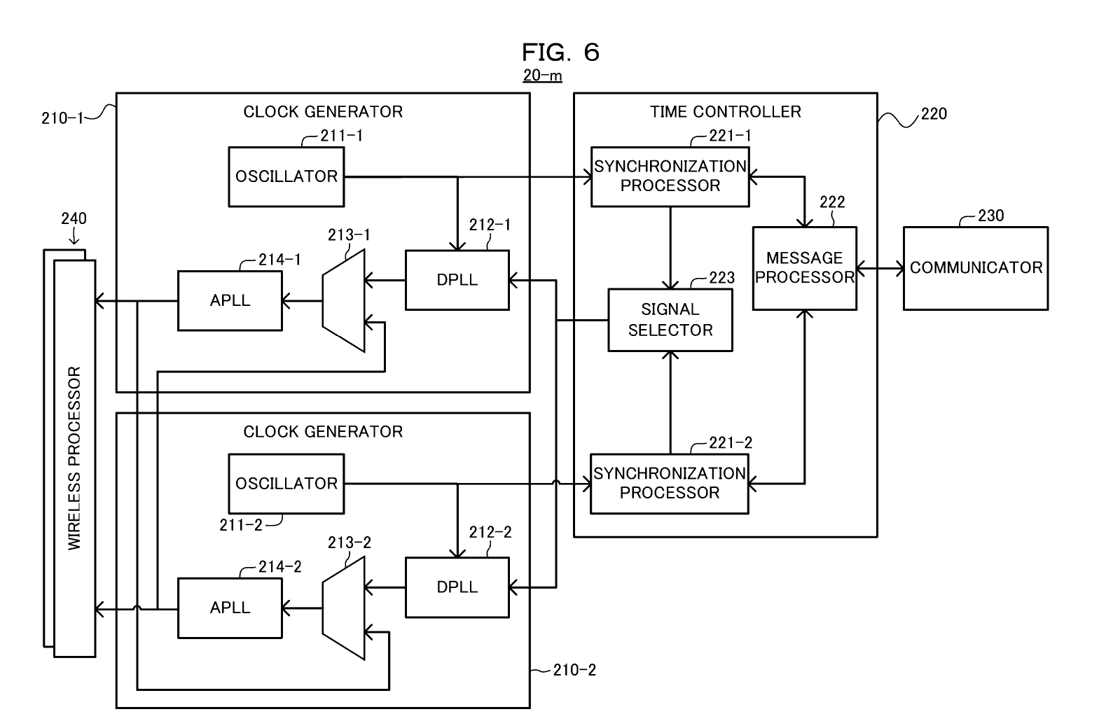

For example, as illustrated in FIG. 6, the base station 20-m includes two clock generators 210-1 and 210-2, a time controller 220, a communicator 230, and at least one wireless processor 240. For example, the clock generator 210-k, the time controller 220, the communicator 230, and wireless processor 240 each may be achieved with a card, a board, or an adaptor detachably attached to the base station 20-m. Here, the symbol k represents each integer of one and two.

The clock generator 210-k generates a clock signal based on a 1 PPS signal output from the time controller 220 and outputs the generated clock signal to the wireless processor 240.

The time controller 220 is provided with a clock indicating a time. The time controller 220 generates PTP messages based on the time indicated by the clock therein and outputs the generated PTP messages to the communicator 230. The time controller 220 controls the time indicated by the clock on the basis of the PTP messages received in the communicator 230. The time controller 220 generates a 1 PPS signal based on the controlled time and outputs the generated 1 PPS signal to the clock generators 210-1 and 210-2. Alternatively, on the basis of the 1 PPS signal generated by the time controller 220, the timing at which a wireless frame is transmitted may be determined.

In this embodiment, the time controller 220 is achieved by a Field Programmable Gate Array (FPGA), but may alternatively be achieved by a Large Scale Integration (LSI).

The communicator 230 transmits PTP messages output from the time controller 220 to the reference device 10. Furthermore, the communicator 230 receives PTP messages from the reference device 10 and outputs the received PTP messages to the time controller 220.

The wireless processor 240 generates a wireless signal based on a clock signal output from the clock generator 210-k. The base station 20-m communicates with the mobile terminal 30-n, using the wireless signal generated by the wireless processor 240.

In the first embodiment, the base station 20-m detects whether a failure occurs in the clock generator 210-1. If no failure occurs in the clock generator 210-1, the base station 20-m controls the clock generator 210-1 to be an output source of a clock signal to be input into the wireless processor 240. In contrast, if a failure occurs in the clock generator 210-1, the base station 20-m switches an output source of a clock signal to be input into the wireless processor 240 from the clock generator 210-1 to the clock generator 210-2.

In other words, the clock generator 210-2 is used as a backup for the clock generator 210-1.

Next, description will now be made in relation to the clock generator 210-k.

The clock generator 210-k includes an oscillator 211-k, a Digital Phase Locked Loop (DPLL) 212-k, a selector 213-k, and an Analog Phase Locked Loop (APLL) 214-k.

The oscillator 211-k generates an oscillation single having a predetermined frequency. The oscillator 211-k of the first embodiment is an Oven Controlled Crystal Oscillator (OCXO). Alternatively, the oscillator 211-k may be a quartz oscillator which is different from the OCXO, a ceramic oscillator, a silicon oscillator, a rubidium atom oscillator, and a cesium atom oscillator. The oscillator 211-k outputs the generated oscillation signal to the DPLL 212-k and a synchronization processor 221-k that is to be detailed below.

The DPLL 212-k generates a clock signal based on the oscillation signal output from the oscillator 211-k and a 1 PPS signal output from the time controller 220. For example, DPLL 212-k generates a clock signal having a frequency of 3.84 MHz by using the 1 PPS signal as a reference signal, and outputs the generated clock signal to the selector 213-k.

Into the selector 213-k, the clock signal output from the DPLL 212-k and a clock signal output from an APLL 214-q included in the other clock generator 210-q different from the clock generator 210-k including the same selector 213-k are input. The symbol q here represents an integer of 1 or 2 that is different from k.

The selector 213-k selects one from the two input clock signals and outputs the selected clock signal to the APLL 214-k.

In the first embodiment, when no failure occurs in the clock generator 210-1, the selector 213-1 selects the clock signal output from the DPLL 212-1 while the selector 213-2 selects the clock signal output from the APLL 214-1.

In contrast, when a failure occurs in the clock generator 210-1 in the first embodiment, the selector 213-1 selects the clock signal output from the APLL 214-2 while the selector 213-2 selects the clock signal output from the DPLL 212-2.

The APLL 214-k generates a clock signal synchronized with the clock signal output from the selector 213-k, and outputs the generated clock signal to the wireless processor 240. In this embodiment, the APLL 214-k suppresses jitter contained in a clock signal.

Next, description will now be made in relation to the time controller 220.

The time controller 220 includes synchronization processors 221-1 and 221-2, a message processor 222, and a signal selector 223.

The synchronization processor 221-k operates in synchronization with the oscillation signal output from the oscillator 211-k and includes a clock that indicates the time. The synchronization processor 221-k generates a 1 PPS signal with reference to the time indicated by the clock and outputs the generated 1 PPS signal to the signal selector 223. The synchronization processor 221-k is an example of a time synchronization device and may be referred to as a time synchronization circuit.

When the communicator 230 receives a synchronization message, the message processor 222 outputs the time t₁ contained in the received synchronization message and the time t₂ that the clock provided in the synchronization processor 221-k indicates at the time point when the synchronization message is received to the synchronization processor 221-k.

When the synchronization message is received, the message processor 222 further outputs a delay request message to the communicator 230. In addition to the above, the message processor 222 outputs the time t₃ that the clock provided in the synchronization processor 221-k indicates at the time point when the delay request message is transmitted to the synchronization processor 221-k. Furthermore, when the communicator 230 receives a delay response message, the message processor 222 outputs the time t₄ contained in the delay response message to the synchronization processor 221-k.

The synchronization processor 221-k corrects the time indicated by the clock on the basis of the times t₁-t₄ output from the message processor 222.

Into the signal selector 223, the 1 PPS signals output from the synchronization processors 221-1 and 221-2 are input. The signal selector 223 selects one from the two input 1 PPS signals and outputs the selected 1 PPS signal to the DPLLs 212-1 and 212-2.

In the first embodiment, when no failure occurs in the clock generator 210-1, the signal selector 223 selects the 1 PPS signal input from the synchronization processor 221-1. In contrast, when a failure occurs in the clock generator 210-1, the signal selector 223 selects the 1 PPS signal input from the synchronization processor 221-2.

Next, description will now be made in relation to the synchronization processor 221-k.

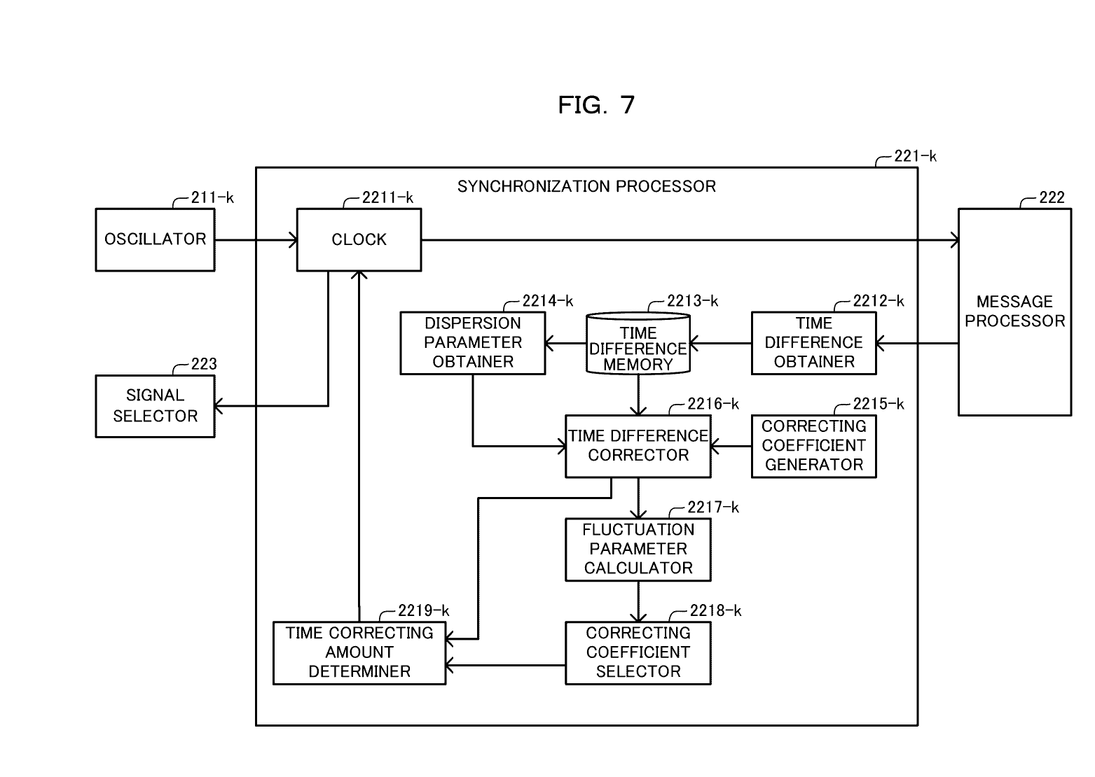

As illustrated in FIG. 7, the synchronization processor 221-k includes, for example, a clock 2211-k, a time difference obtainer 2212-k, a time difference memory 2213-k, a dispersion parameter obtainer 2214-k, a correcting coefficient generator 2215-k, a time difference corrector 2216-k, a fluctuation parameter calculator 2217-k, a correcting coefficient selector 2218, and a time correcting amount determiner 2219-k.

The clock 2211-k operates in synchronization with the oscillation signal output from the oscillator 211-k and includes a clock that indicates the time. The clock 2211-k generates a 1 PPS signal with reference to the time indicated by the clock and outputs the generated 1 PPS signal to the signal selector 223.

The time difference obtainer 2212-k obtains the first time difference tₘₛ and the second time difference tₛₘ based on the times t₁-t₄ obtained by the message processor 222, using Expressions 1 and 2.

The time difference memory 2213-k includes a memory and stores the first time difference tₘₛ and the second time difference tₛₘ obtained by the time difference obtainer 2212-k into the memory in association with the time points when the first time difference tₘₛ and the second time difference tₛₘ are obtained, respectively. Storing the first time difference tₘₛ and the second time difference tₛₘ into the memory may also be referred to as memorizing the first time difference tₘₛ and the second time difference tₛₘ.

The dispersion parameter obtainer 2214-k calculates a first dispersion parameter and a second dispersion parameter based on the first time difference tₘₛ and the second time difference tₛₘ stored in the time difference memory 2213-k each time a predetermined obtaining time elapses. The calculating of the first dispersion parameter and the second dispersion parameter is an example of obtaining of the first dispersion parameter and the second dispersion parameter.

The obtaining time includes multiple time points each at which a set of the times t₁-t₄ are obtained. In the first embodiment, the obtaining time is a time for which a predetermined obtaining number (e.g., 512) of sets of the times t₁-t₄ are obtained. Specifically, the first dispersion parameter and the second dispersion parameter of this embodiment are calculated on the basis of the first time differences tₘₛ and the second time differences tₛₘ obtained during a time period (e.g., obtaining time period) between the time point of the calculating and a time point earlier by the obtaining time than the time of the calculating.

The first dispersion parameter represents the extent of dispersion of the first time differences tₘₛ. In the first embodiment, the first dispersion parameter Dₘₛ is represented by Expression 4. The term tₘₛ(s) represents the first time difference tₘₛ obtained for the s-th time in an obtaining time period. The symbol s represents each integer of 1 to S. The symbol S represents the obtaining number. In the first embodiment, the extent of dispersion of the first time difference tₘₛ increases as the first dispersion parameter Dₘₛ increases.

$${D}_{ms} = {\sum }_{s = 1}^{S - 1} {\{ {t}_{ms} ( s + 1 ) - {t}_{ms} ( s ) \}}^{2} \qquad [ Expression 4 ]$$

Likewise, the second dispersion parameter represents the extent of dispersion of the second time differences tₛₘ. In the first embodiment, the second dispersion parameter Dₛₘ is represented by Expression 5. The term tₛₘ(s) represents the second time difference tₛₘ obtained for the s-th time in an obtaining time period. In the first embodiment, the extent of dispersion of the second time difference tₛₘ increases as the second dispersion parameter Dₛₘ increases.

$${D}_{sm} = {\sum }_{s = 1}^{S - 1} {\{ {t}_{ms} ( s + 1 ) - {t}_{ms} ( s ) \}}^{2} \qquad [ Expression 5 ]$$

The first and second dispersion parameters may be calculated with expressions different from Expressions 4 and 5, respectively. For example, the first and second dispersion parameters may be calculated with expressions representing a standard deviation or a dispersion.

The correcting coefficient generator 2215-k includes a memory and generates multiple different correcting coefficients and stores the generated multiple correcting coefficients into the memory. Alternatively, the correcting coefficient generator 2215-k may retain multiple different correcting coefficients in advance. In the first embodiment, the correcting coefficient generator 2215-k generates 127 correcting coefficients.

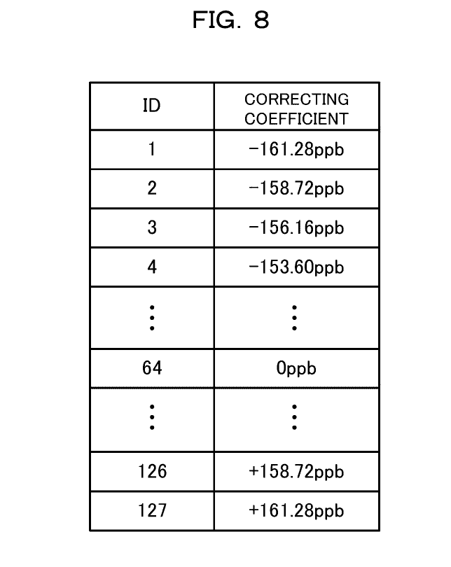

As illustrated in FIG. 8, the 127 correcting coefficients are stored in the memory in association with identifiers (IDs) that identify respective corresponding correcting coefficients in the first embodiment. In FIG. 8, the unit of 1 ppb is represents 10⁻⁷%. Here, the term ppb is an abbreviation for Parts Per Billion. The IDs of the first embodiment are each integer of from one to 127. The number of correcting coefficients each associated with an ID increases as the number of IDs increases.

The correcting coefficients are preferably set to have a range which is wider by a predetermined margin than the range of an allowable error of an oscillation signal generated by the oscillator 211-k. The first embodiment assumes that the allowable error of an oscillation signal generated by the oscillator 211-k is ±150 ppb.

The time difference corrector 2216-k selects a time difference relating to one of the dispersion parameters representing a smaller extent of dispersion obtained by the dispersion parameter obtainer 2214-k from the first time difference tₘₛ and the second time difference tₛₘ. In the first embodiment, when the first dispersion parameter Dₘₛ is smaller than the second dispersion parameter Dₛₘ, the time difference corrector 2216-k selects the first time difference tₘₛ. On the other hand, when the first dispersion parameter Dₘₛ is equal to or larger than the second dispersion parameter Dₛₘ, the time difference corrector 2216-k selects the second time difference tₛₘ.

The time difference selected from the first time difference tₘₛ and the second time difference tₛₘ may be referred to as the selected time difference. Likewise, the time difference not selected from the first time difference tₘₛ and the second time difference tₛₘ may be referred to as the non-selected time difference.

The time difference corrector 2216-k corrects the selected time difference for each of the multiple correcting coefficients stored in the correcting coefficient generator 2215-k. Specifically, the selected time difference is corrected by adding the respective a product of a time period between a reference time point and a time point when each time difference stored in the time difference memory 2213-k is obtained and the correcting coefficient to the same time difference.

In the first embodiment, when the selected time difference is the first time difference tₘₛ, the time difference corrector 2216-k corrects the selected time difference with Expression 6. The term C(u) represents a correcting coefficient associated with ID u among the U (in this example 127) correcting coefficients stored in the correcting coefficient generator 2215-k. The symbol u represents each integer of one to U. The term tₘₛ′ (s,u) represents a value obtained by correcting the first time difference tₘₛ(s) obtained for the s-th time within the obtaining time period using the correcting coefficient C(u). The term v(s) represents the time point when the first time difference tₘₛ(s) obtained for the s-th time within the obtaining time period is obtained. In the first embodiment, the reference time point is a time point when the first time difference tₘₛ(1) obtained for the first time within the obtaining time period is obtained.

tₘₛ′(s, u)=tₘₛ(s)+{v(s)−v(1)}C(u) [Expression 6]

In the first embodiment, when the selected time difference is the second time difference tₛₘ, the time difference corrector 2216-k corrects the selected time difference with Expression 7. The term tₛₘ′ (s,u) represents a value obtained by correcting the second time difference tₛₘ(s) obtained for the s-th time within the obtaining time period using the correcting coefficient C(u). The term v(s) represents the time point when the second time difference tₛₘ(s) obtained for the s-th time within the obtaining time period is obtained. In the first embodiment, the reference time point is a time point when the second time difference tₛₘ(1) obtained for the first time within the obtaining time period is obtained.

tₛₘ′(s, u)=tₛₘ(s)+{v(s)−v(1)}C(u) [Expression 7]

The fluctuation parameter calculator 2217-k calculates a fluctuation parameter for each of the multiple correcting coefficients stored in the correcting coefficient generator 2215-k, using the selected time difference corrected by the time difference corrector 2216-k. A fluctuation parameter of the first embodiment increases as the absolute value of a fluctuation rate of the selected time difference having undergone the correction with respect to the time increases. For example, a fluctuation rate of the selected time difference having undergone the correction with respect to the time may be the slope of a linear function approximately representing the selected time difference within the obtaining time period.

A fluctuation parameter for each correcting coefficient is calculated in the following manner.

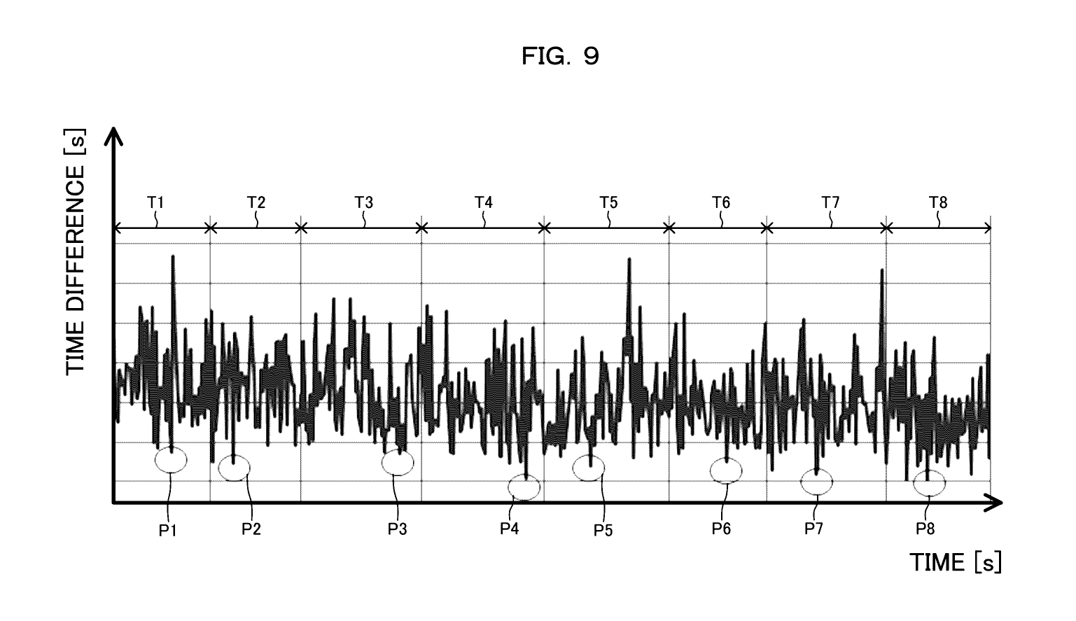

As illustrated in FIG. 9, the fluctuation parameter calculator 2217-k of the first embodiment obtains the minimum values P1-P8 of the selected time differences having undergone the correction during each of the successive multiple (eight in this example) time periods T1-T8 collectively constituting the obtaining time period.

Furthermore, the fluctuation parameter calculator 2217-k calculates the fluctuation parameter based on the obtained minimum values P1-P8 of the selected time difference, using Expression 8. The term E(u) represents the fluctuation parameter for the correcting coefficient C(u). The term tₘᵢₙ(w,u) represents the minimum value of the selected time difference corrected based on the correcting coefficient C(u) in the w-th period among the successive W (eight in this example) time periods collectively constituting the obtaining time period. The symbol “w” represents each integer of one to W.

$$E ( u ) = \sqrt{{\sum }_{w = 1}^{W - 1} {\{ {t}_{min} ( 1 , u ) - {t}_{min} ( w , u ) \}}^{2}} \qquad [ Expression 8 ]$$

In other words, the fluctuation parameter E(u) is calculated on the basis of the absolute value of a difference between the minimum value tₘᵢₙ(1,u) for the selected time difference having undergone the correction of a reference time period and the minimum value tₘᵢₙ(w,u) of the selected time difference having undergone the correction for each of the multiple time periods different from the reference time period. The reference time period of the first embodiment is a leading time period (i.e., the first time period) of the obtaining time period.

The fluctuation parameter for each correcting coefficient is calculated in the above manner.

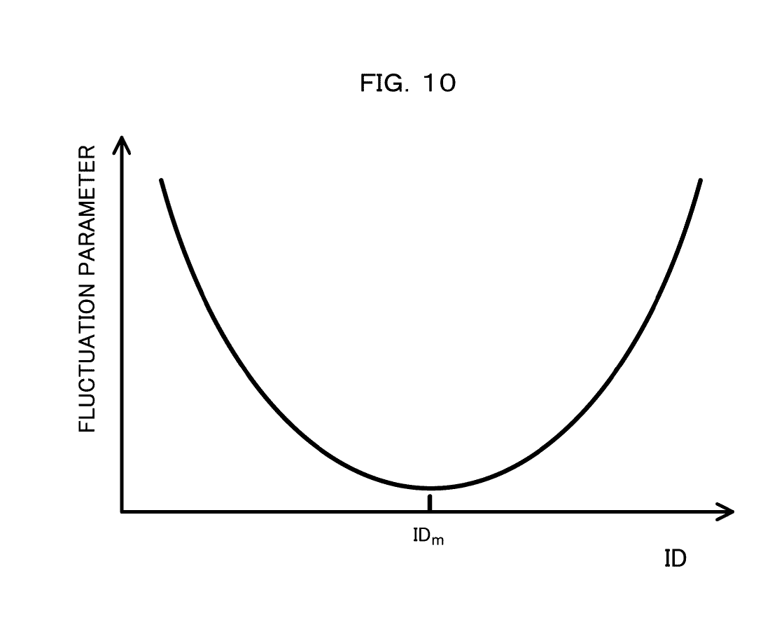

The correcting coefficient selector 2218-k selects a correcting coefficient relating to the minimum fluctuation parameter E(u) calculated by the fluctuation parameter calculator 2217-k among the multiple correcting coefficients stored in the correcting coefficient generator 2215-k. For example, in cases where the fluctuation parameters E(u) calculated by the fluctuation parameter calculator 2217-k fluctuate as depicted in FIG. 10 for the IDs and come to be the minimum at IDₘ, the correcting coefficient selector 2218-k selects the correcting coefficient C(IDₘ) associated with the IDₘ. The correcting coefficient selected in the above manner may also be referred to as the selected correcting coefficient.

The correcting coefficient selector 2218-k may smooth the fluctuation parameters E(u) calculated by the fluctuation parameter calculator 2217-k and select a correcting coefficient on the basis of the smoothed fluctuation parameter E′(u). For example, the smoothing may be carried out using Expression 9.

$${E}^{′} ( u ) = \frac{E ( u - 1 ) + E ( u ) + E ( u + 1 )}{3} \qquad [ Expression 9 ]$$

The time difference corrector 2216-k corrects the non-selected time difference for the correcting coefficient selected by the correcting coefficient selector 2218-k. When the non-selected time difference is the first time difference tₘₛ, the time difference corrector 2216-k corrects the non-selected time difference using Expression 6. On the other hand, when the non-selected time difference is the second time difference tₛₘ, the time difference corrector 2216-k corrects the non-selected time difference using Expression 7. The time difference corrector 2216-k may correct the non-selected time difference for each of the multiple correcting coefficients stored in the correcting coefficient generator 2215-k as performed on the selected time difference.

The time correcting amount determiner 2219-k determines the time correcting amount on the basis of the selected time difference and the non-selected time difference (i.e., the first time difference tₘₛ and the second time difference tₛₘ) corrected by the time difference corrector 2216-k for the selected correcting coefficient. In the first embodiment, the time correcting amount determiner 2219-k determines the time correcting amount Δt based on the minimum value tₘₛₘᵢₙ of the first time difference and the minimum value tₛₘₘᵢₙ of the second time difference, using Expression 10.

$$Δ t = \frac{{t}_{smmin} - {t}_{msmin}}{2} \qquad [ Expression 10 ]$$

The minimum value tₘₛₘᵢₙ of the first time difference is the minimum value within the obtaining time period among the first time differences tₘₛ corrected by the time difference corrector 2216-k for the selected correcting coefficient. The minimum value tₛₘₘᵢₙ of the second time difference is the minimum value within the obtaining time period among the second time differences tₛₘ corrected by the time difference corrector 2216-k for the selected correcting coefficient.

The clock 2211-k corrects the time indicated by the clock based on the time correcting amount Δt determined by the time correcting amount determiner 2219-k.

In the first embodiment, the clock 2211-k corrects the time indicated by the clock to coincide with the sum of the time before the correction and the time correcting amount Δt determined by the time correcting amount determiner 2219-k. The pulse of the 1 PPS signal generated by the clock 2211-k is generated at the time point corresponding to the sum of the time point before the correction and the time correcting amount Δt.

This means that the synchronization processor 221-k synchronizes the time of the base station 20-m with that of the reference device 10. Accordingly, the clock 2211-k is an example of a time synchronizer.

(Operation)

Next, description will now be made in relation to the operation of the base station 20-m.

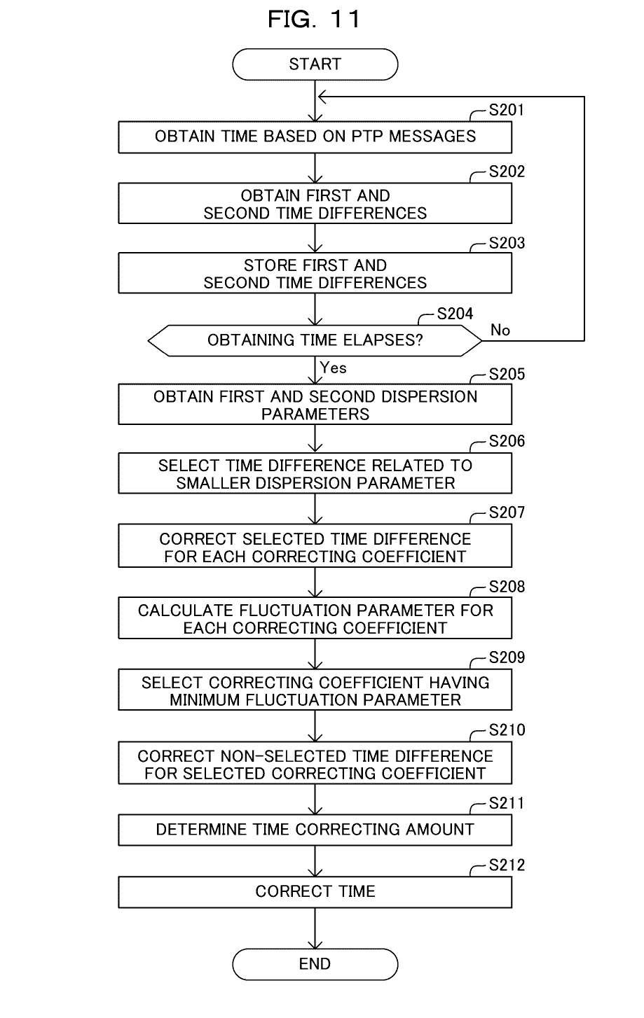

For example, the base station 20-m carries out the process in FIG. 11 to synchronize the time of the base station 20-m with the reference time each time a predetermined execution period elapses.

Upon start of the process in FIG. 11, the base station 20-m obtains times t₁-t₄ on the basis of PTP messages transmitted to and received from the reference device 10 (step S201 in FIG. 11).

Next, the base station 20-m obtains the first time difference tₘₛ and the second time difference tₛₘ based on the obtained times t₁-t₄ (step S202 in FIG. 11).

Then, the base station 20-m stores the obtained first time difference tₘₛ and second time difference tₛₘ into the memory (step S203 in FIG. 11).

Next, the base station 20-m determines whether the obtaining time elapses from the start of the process in FIG. (step S204 in FIG. 11).

If the obtaining time has not elapsed from the start of the process in FIG. 11 yet, the base station 20-m makes “No” determination and returns to step S201 in FIG. 11 to repeat the process of steps S201-S204.

After that, at the time point when the obtaining time elapses from the start of the process in FIG. 11, the base station 20-m makes “Yes” determination in step S204. The base station 20-m obtains the first dispersion parameter Dₘₛ and the second dispersion parameter Dₛₘ on the basis of the stored first time difference tₘₛ and second time difference tₛₘ (step S205).

The base station 20-m selects one time difference tₘₛ or tₛₘ relating to smaller one of the dispersion parameters Dₘₛ and Dₛₘ obtained in step S205 from the first time difference tₘₛ and the second time difference tₛₘ as the selected time difference (step S206 in FIG. 11).

The base station 20-m corrects each of the selected time differences obtained in step S202 in FIG. 11 within the obtaining time period using each correcting coefficient C (step S207 in FIG. 11).

Next, the base station 20-m calculates a fluctuation parameter E based on the selected time differences corrected in step S207 in FIG. 11 for each correcting coefficient C (step S208 in FIG. 11).

Then, the base station 20-m selects a correcting coefficient C relating to the smallest fluctuation parameter E calculated in step S208 in FIG. 11 as the selected correcting coefficient among the multiple correcting coefficients C (step S209 in FIG. 11).

Next, the base station 20-m corrects each of the non-selected time differences obtained within the obtaining time period in step S202 in FIG. 11 for the selected correcting coefficient (step S210 in FIG. 11).

The base station 20-m determines the time correcting amount At based on the minimum value tₘₛₘᵢₙ of the first time difference tₘₛ corrected for the selected correcting coefficient and the minimum value tₛₘₘᵢₙ of the second time difference tₛₘ corrected for the selected correcting coefficient (step S211 in FIG. 11).

After that, the base station 20-m corrects the time indicated by the clock provided in the base station 20-m based on the time correcting amount At determined in step S211 in FIG. 11 (step S212 in FIG. 11). Consequently, the time indicated in the base station 20-m is synchronized with the time indicated in the reference device 10.

Then, the base station 20 finishes the process in FIG. 11.

As described above, the synchronization processor 221-k of the first embodiment obtains the time difference at each of different time points. In addition, the synchronization processor 221-k corrects, for each of the correcting coefficients, the obtained time difference by adding a product of a time period from the reference time point to a time point when the time difference is obtained and the correcting coefficient to the time difference.

In addition, the synchronization processor 221-k calculates, for each correcting coefficient, a fluctuation parameter that increases as the absolute value of a rate of fluctuation of the corrected time difference with respect to time increases. Furthermore, the synchronization processor 221-k selects a correcting coefficient relating to a smallest fluctuation rate represented by the above calculated fluctuation parameter among the multiple correcting coefficients. In addition, the synchronization processor 221-k synchronizes the time indicated by the base station 20-m with the time indicated by the reference device 10 on the basis of the time difference corrected for the selected correcting coefficient.

This can synchronize the time indicated by the base station 20-m with the time indicated by the reference device 10 on the basis of the time difference in which a component that fluctuates with a frequency deviation is suppressed. Accordingly, using the minimum value of the time difference within a predetermined time period (in this embodiment, the obtaining time period), the first embodiment can precisely synchronize the time indicated by the base station 20-m with the time indicated by the reference device 10.

Furthermore, even if the packet transmission time largely deviates, the synchronization processor 221-k can precisely suppress a component that fluctuates with a frequency deviation and that is contained in the time difference as compared with the case the frequency deviation is estimated using a scheme of linear regression. Accordingly, the first embodiment can precisely synchronize the time indicated by the base station 20-m with the time indicated by the reference device 10.

The synchronization processor 221-k of the first embodiment obtains the first time difference tₘₛ and the second time difference tₛₘ at each of multiple time points. In addition, the synchronization processor 221-k obtains the first dispersion parameter Dₘₛ representing an extent of the dispersion of the first time differences tₘₛ and the second dispersion parameter Dₛₘ representing an extent of the dispersion of the second time differences tₛₘ.

Furthermore, the synchronization processor 221-k corrects one time difference relating to a smaller one of the obtained dispersion parameters from the first time difference tₘₛ and the second time difference tₛₘ using each correcting coefficient. In addition, the synchronization processor 221-k calculates a fluctuation parameter of one time difference relating to a smaller one of the obtained dispersion parameters from the first time difference tₘₛ and the second time difference tₛₘ for each correcting coefficient.

The synchronization processor 221-k corrects one time difference relating to a larger one of the obtained dispersion parameters from the first time difference tₘₛ and the second time difference tₛₘ using a correcting coefficient selected on the basis of the fluctuation parameter. In addition, the synchronization processor 221-k synchronizes the times on the basis of the first time difference tₘₛ and the second time difference tₛₘ corrected for the selected correcting coefficient.

The extent of deviation of the packet transmission time varies with the direction in which a packet travels between the reference device 10 and the base station 20-m. A smaller extent of deviation of the packet transmission time more enhances the precision of the fluctuation parameter in exhibiting the absolute value of a fluctuation rate of a time difference with respect to the time. Besides, the extent of the dispersion of the time difference precisely reflects the extent of deviation of the packet transmission time. Accordingly, the synchronization processor 221-k can precisely suppress a component that fluctuates with a frequency deviation and that is contained in the time difference. Consequently, the first embodiment can precisely synchronize the time indicated by the base station 20-m with the time indicated by the reference device 10.

Furthermore, the synchronization processor 221-k of the first embodiment calculates the fluctuation parameter on the basis of the minimum value of the corrected time difference for each of multiple successive time periods.

This can improve the precision of the fluctuation parameter in exhibiting a fluctuation rate of the absolute value of the time difference with respect to time. Accordingly, it is possible to precisely suppress the component that fluctuates with the frequency deviation and that is included in the time difference. Consequently, this can precisely synchronize the time indicated by the base station 20-m with the time indicated by the reference device 10.

Furthermore, the synchronization processor 221-k of the first embodiment calculates the fluctuation parameter on the basis of the absolute value of the difference between the minimum value tₘₛₘᵢₙ of the first time difference and the minimum value tₛₘₘᵢₙ of the second time difference. The minimum value tₘₛₘᵢₙ of the first time difference is the minimum value among the corrected first time differences tₘₛ within the reference time period among the above multiple time periods. The minimum value tₛₘₘᵢₙ of the second time difference is the minimum value among the corrected time differences for each of the time periods except for the reference time period among the above multiple time periods.

This can improve the precision of the fluctuation parameter in exhibiting a fluctuation rate of the absolute value of the time difference with respect to time. Accordingly, it is possible to precisely suppress the component that fluctuates with the frequency deviation and that is included in the time difference. Consequently, this can precisely synchronize the time indicated by the base station 20-m with the time indicated by the reference device 10.

Furthermore, the synchronization processor 221-k of the first embodiment synchronizes the times on the basis of the minimum value of the corrected time differences for a predetermined time period (in this embodiment, the obtaining time period).

A shorter packet transmission time period brings the time difference closer to the difference at a certain time point between the times indicated by the reference device 10 and the time indicated by the base station 20-m. Accordingly, synchronization processor 221-k can precisely synchronize the time indicated by the base station 20-m with the time indicated by the reference device 10.

According to the foregoing embodiment, the time can be precisely synchronized between communication devices.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A time synchronization device comprising:
a time difference obtainer that obtains, at each of a plurality of time points, a time difference between a time indicated by one of a first communication device and a second communication device at a time point when the one communication device transmits a packet and a time indicated by a remaining one of the first communication device and the second communication device at a time point when the remaining communication device receives the packet;
a time difference corrector that corrects, for each of a plurality of coefficients being different from one another, the obtained time difference by adding a product of a time period from a reference time point to a time point when the time difference is obtained and the coefficient to the time difference;
a fluctuation parameter calculator that calculates a fluctuation parameter for each of the plurality of coefficients, the fluctuation parameter increasing as an absolute value of a fluctuation rate of the corrected time difference with respect to time increases;
a coefficient selector that selects a coefficient related to the calculated fluctuation parameter representing a smallest fluctuation rate among the plurality of coefficients; and
a time synchronizer that synchronizes a time indicated by the first communication device with a time indicated by the second communication device using the time difference corrected with the selected coefficient.

2. The time synchronization device according to claim 1, wherein
the time difference obtainer
obtains, at each of the plurality of time points, a first time difference between a time indicated by the first communication device at a time point when the first communication device transmits a packet and a time indicated by the second communication device at a time point when the second communication device receives the packet, and
obtains, at each of the plurality of time points, a second time difference between a time indicated by the second communication device at a time point when the second communication device transmits a packet and a time indicated by the first communication device at a time point when the first communication device receives the packet;
the time synchronization device further comprises a dispersion parameter obtainer that obtains a first dispersion parameter representing an extent of dispersion of a plurality of the first time differences and a second dispersion parameter representing an extent of dispersion of a plurality of the second time differences;
the time difference corrector performs the correction of the time difference for one time difference from among the first time difference and the second time difference, the one time difference relating to a smaller extent of dispersion from among the extents represented by the first dispersion parameter and the second dispersion parameter;
the fluctuation parameter calculator performs the calculation of the fluctuation parameter for the one time difference;
the time difference corrector performs the correction of the time difference for another time difference from among the first time difference and the second time difference using the selected coefficient, the another time difference relating to a larger extent of dispersion from among the extents represented by the first dispersion parameter and the second dispersion parameter; and
the time synchronizer performs the synchronization of the times using the first time difference corrected with the selected coefficient and the second time difference corrected with the selected coefficient.

3. The time synchronization device according to claim 1, wherein the fluctuation parameter is calculated using a minimum value of the corrected time difference within each of a plurality of successive time periods.

4. The time synchronization device according to claim 3, wherein the fluctuation parameter is calculated using an absolute value of a difference between a minimum value of the corrected time difference within a reference time period among the plurality of successive time periods and a minimum value of the corrected time difference within each time period except for the reference time period among the plurality of successive time periods.

5. The time synchronization device according to claim 1, wherein the time synchronizer performs the synchronization of the times using a minimum value of the corrected time difference within a predetermined time period.

6. A base station comprising:
a time difference obtainer that obtains, at each of a plurality of time points, a time difference between a time indicated by one of a first communication device and a second communication device at a time point when the one communication device transmits a packet and a time indicated by a remaining one of the first communication device and the second communication device at a time point when the remaining communication device receives the packet;
a time difference corrector that corrects, for each of a plurality of coefficients being different from one another, the obtained time difference by adding a product of a time period from a reference time point to a time point when the time difference is obtained and the coefficient to the time difference;
a fluctuation parameter calculator that calculates a fluctuation parameter for each of the plurality of coefficients, the fluctuation parameter increasing as an absolute value of a fluctuation rate of the corrected time difference with respect to time increases;
a coefficient selector that selects a coefficient related to the calculated fluctuation parameter representing a smallest fluctuation rate among the plurality of coefficients; and
a time synchronizer that synchronizes a time indicated by the first communication device with a time indicated by the second communication device using the time difference corrected with the selected coefficient, wherein
the base station is one of the first communication device and the second communication device.

7. The base station according to claim 6, wherein
the time difference obtainer
obtains, at each of the plurality of time points, a first time difference between a time indicated by the first communication device at a time point when the first communication device transmits a packet and a time indicated by the second communication device at a time point when the second communication device receives the packet, and
obtains, at each of the plurality of time points, a second time difference between a time indicated by the second communication device at a time point when the second communication device transmits a packet and a time indicated by the first communication device at a time point when the first communication device receives the packet;
the time synchronization device further comprises a dispersion parameter obtainer that obtains a first dispersion parameter representing an extent of dispersion of a plurality of the first time differences and a second dispersion parameter representing an extent of dispersion of a plurality of the second time differences;
the time difference corrector performs the correction of the time difference for one time difference from among the first time difference and the second time difference, the one time difference relating to a smaller extent of dispersion from among the extents represented by the first dispersion parameter and the second dispersion parameter;
the fluctuation parameter calculator performs the calculation of the fluctuation parameter for the one time difference;
the time difference corrector performs the correction of the time difference for another time difference from among the first time difference and the second time difference using the selected coefficient, the another time difference relating to a larger extent of dispersion from among the extents represented by the first dispersion parameter and the second dispersion parameter; and
the time synchronizer performs the synchronization of the times using the first time difference corrected with the selected coefficient and the second time difference corrected with the selected coefficient.

8. The base station according to claim 6, wherein the fluctuation parameter is calculated using a minimum value of the corrected time difference within each of a plurality of successive time periods.

9. The base station according to claim 8, wherein the fluctuation parameter is calculated using an absolute value of a difference between a minimum value of the corrected time difference within a reference time period among the plurality of successive time periods and a minimum value of the corrected time difference within each time period except for the reference time period among the plurality of successive time periods.

10. The base station according to claim 6, wherein the time synchronizer performs the synchronization of the times using a minimum value of the corrected time difference within a predetermined time period.

11. A method for synchronizing a time comprising:
obtaining, at each of a plurality of time points, a time difference between a time indicated by one of a first communication device and a second communication device at a time point when the one communication device transmits a packet and a time indicated by a remaining one of the first communication device and the second communication device at a time point when the remaining communication device receives the packet;
correcting, for each of a plurality of coefficients being different from one another, the obtained time difference by adding a product of a time period from a reference time point to a time point when the time difference is obtained and the coefficient to the time difference;
calculating a fluctuation parameter for each of the plurality of coefficients, the fluctuation parameter increasing as an absolute value of a fluctuation rate of the corrected time difference with respect to time increases;
selecting a coefficient related to the calculated fluctuation parameter representing a smallest fluctuation rate among the plurality of coefficients; and
synchronizing a time indicated by the first communication device with a time indicated by the second communication device using the time difference corrected with the selected coefficient.

12. The method according to claim 11, further comprising:
obtaining, at each of the plurality of time points, a first time difference between a time indicated by the first communication device at a time point when the first communication device transmits a packet and a time indicated by the second communication device at a time point when the second communication device receives the packet,
obtaining, at each of the plurality of time points, a second time difference between a time indicated by the second communication device at a time point when the second communication device transmits a packet and a time indicated by the first communication device at a time point when the first communication device receives the packet; and
obtaining a first dispersion parameter representing an extent of dispersion of a plurality of the first time differences and a second dispersion parameter representing an extent of dispersion of a plurality of the second time differences, wherein
the correcting is performed on the time difference for one time difference from among the first time difference and the second time difference, the one time difference relating to a smaller extent of dispersion from among the extents represented by the first dispersion parameter and the second dispersion parameter,
the calculating is performed on the fluctuation parameter for the one time difference,
the correcting is performed on the time difference for another time difference from among the first time difference and the second time difference using the selected coefficient, the another time difference relating to a larger extent of dispersion from among the extents represented by the first dispersion parameter and the second dispersion parameter, and
the synchronizing is performed on the times using the first time difference corrected with the selected coefficient and the second time difference corrected with the selected coefficient.

13. The method according to claim 11, further comprising calculating the fluctuation parameter using a minimum value of the corrected time difference within each of a plurality of successive time periods.

14. The method according to claim 13, further comprising calculating the fluctuation parameter using an absolute value of a difference between a minimum value of the corrected time difference within a reference time period among the plurality of successive time periods and a minimum value of the corrected time difference within each time period except for the reference time period among the plurality of successive time periods.

15. The method according to claim 11, wherein the synchronization of the times is performed using a minimum value of the corrected time difference within a predetermined time period.
